(19) United States
(12) Patent Application Publication
(10) Pub. No.: US 2007/0218722 A1
(43) Pub. Date: Sep. 20, 2007

(54) Electrical connector assembly

(75) Inventors: Hsiang-Ping Chen, Tu-Cheng (TW); Tsu-Yang Wu, Tu-Cheng (TW)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 11/725,838

(22) Filed: Mar. 20, 2007

(30) Foreign Application Priority Data
Mar. 20, 2006 (TW) 95204565

(51) Int. Cl. H01R 13/44

(52) U.S. Cl. 439/135

(57) ABSTRACT

An electrical connector assembly comprising a base defining a plurality of passageways and a conjugate member, a plurality of terminals residing in corresponding passageways, and a pick up cap being detachably mounted on the base and defining a conjugate post. The conjugate member having a hole and the conjugate post having a plurality of interferential robs for abutting against the interior wall surface of the conjugate hole. With this configuration, there is a reserved space to hold the plastic scrap produced by the conjugate post and the conjugate hole when the electrical connector is mating with the pick up cap, so that the pick up cap can be easily mounted on the electrical connector.

### BACKGROUND OF THE INVENTION

1. Field of the Invention

The present invention relates to the art of an electrical connector assembly, and more specifically to a pick up cap for mechanically carrying an electrical connector on an electrical circuit substrate, e.g. a printed circuit board (PCB)

2. Description of the Prior Art

With the development of the connector industry toward the miniaturized, high-density and more reliable trends, generally, this typically leads to a problem, e.g. how to accurately position such a tiny and high-density connector on a PCB. To resolve the above problem, a pick up cap is generally provided to carry an electrical connector and accurately place the electrical connector on a predetermined real estate of a corresponding PCB.

Turning to FIGS. 1-2, there is shown a conventional electrical connector assembly 100′ including an electrical connector with an insulated base 10′ and a plurality of terminals 20′ residing in the base 10′, and a pick up cap 30′ mounted on the electrical connector. The insulated base 10′ has a base member 102′ and a conjugate member 104′.

The base member 102′ defines a plurality of passageways 1020′ and a number of terminals 20′ residing in the corresponding passageways 1020′, respectively. The conjugate member 104′ has a conjugate hole 1040′ defined in the middle of the electrical connector. A pair of parallel spaced ridges 1022′ is disposed on opposite sides of the conjugate member 104′.

The plurality of terminals 20′ is secured on the insulated base 10′. Each contact 20′ integrally forms a base portion 201′, a first arm portion 202′ extending upwardly from the base portion 201′ and a second arm portion 203′ extending from a distal end of the base portion 201′.

The pick up cap 30′ is detachably mounted on the electrical connector, and has a plate-like body, which is formed with a smooth major top surface 300′ for being sucked by a vacuum device (not shown) and a bottom surface opposing to the top surface for mating with the electrical connector. A conjugate post 302′ having a recess 3020′ extends from the bottom surface of the pick up cap 300′ away from the top surface 300′ for coupling in corresponding conjugate hole 1040′ of the electrical connector. A pair of engaging projections 304′ engage with the ridges 1022′ when the pick up cap 30′ is mounted on the electrical connector.

With this configuration, as often happens in the actual practice, when the pick up cap 30′ is attached to the electrical connector through the conjugate post 302′ and the conjugate hole 1040′, there is no space to hold the plastic scrap produced by the conjugate post 302′ rubbing against the conjugate hole 1040′. The plastic scrap tends to cause an obstacle to prevent the pick up cap 30′ from mounting on the electrical connector. In addition, it is difficult to control the diameter of the conjugate post 302′ and conjugate hole 1040′ such that if the interferential force between the conjugate post 302′ and conjugate hole 1040′ is large, the excessive interference force is acted on the electrical connector and may damage it. As a result, the reliability of the electrical connection may be affected.

Hence, it is strongly desired to provide a new electrical connector assembly which overcomes the disadvantages of the prior art described immediately above.

### SUMMARY OF THE INVENTION

Accordingly, an object of the present invention is to provide a new pick up cap for an electrical connector, wherein the pick up cap mates tightly with the electrical connector and the electrical connector will not be damaged when excessive force is acted thereon.

To fulfill the above-mentioned object, a new electrical connector assembly provided in accordance with the present invention comprises an electrical connector and a pick up cap, the electrical connector defining a plurality of passageways and a number of terminals residing in the corresponding passageways, respectively. A conjugate member with a conjugate hole is defined in the middle of the electrical connector. A pair of parallel spaced ridges is formed on both sides of the conjugate member. The pick up cap defines a smooth major top surface for being sucked by a vacuum device (not shown) and a bottom surface opposite the top surface for mating with the electrical connector. A conjugate post with a plurality of interferential ribs extends from the bottom surface of the pick up cap away from the top surface, for coupling in the corresponding conjugate hole of the electrical connector. A pair of engaging projections with a first mating face and a second mating face engage with corresponding ridges when the pick up cap is mounted on the electrical connector.

With this configuration, the interferential ribs abut against the interior wall surface of the conjugate hole, thereby holding the pick up cap and the insulated base in interference fits. Thus, there is a reserved space to hold the plastic scrap produced by the conjugate post interfering with the conjugate hole so that the pick up cap can be easily mounted on the electrical connector. In addition, the dimension of the ribs can be altered to meet different requirements. Therefore, the conjugate hole is free from being damaged by the conjugate post.

Other objects, features and advantages of the present invention will become more apparent from the following detailed description when taken in conjunction with the accompanying drawings.

### BRIEF DESCRIPTION OF THE DRAWINGS

The features of the present invention which are believed to be novel are set forth with particularity in the appended claims. The invention, together with its object and the advantage thereof, may be best understood by reference to the following detailed description when taken in conjunction with the accompanying drawings, in which like reference numerals identify like elements in the figures and in which:

FIG. 1 is an exploded, isometric view of a conventional electrical connector assembly;

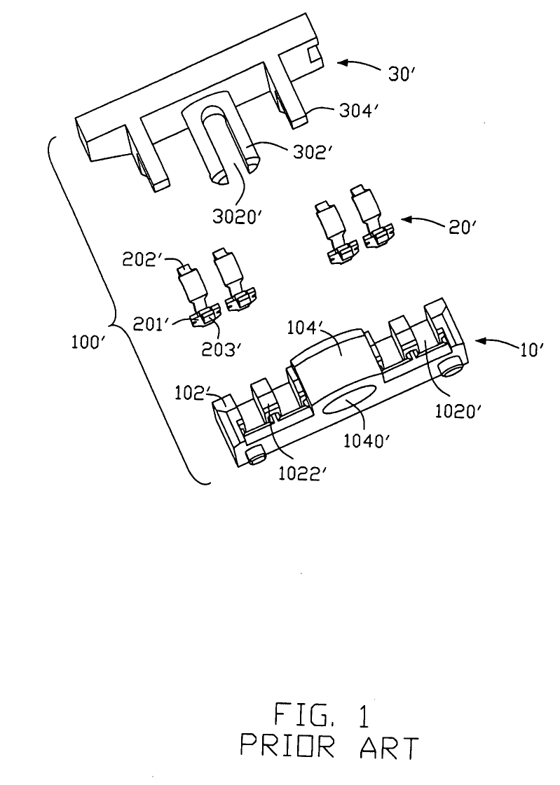

FIG. 2 is similar to FIG. 1, but showing an isometric view of the pick up cap of FIG. 1 from another view;

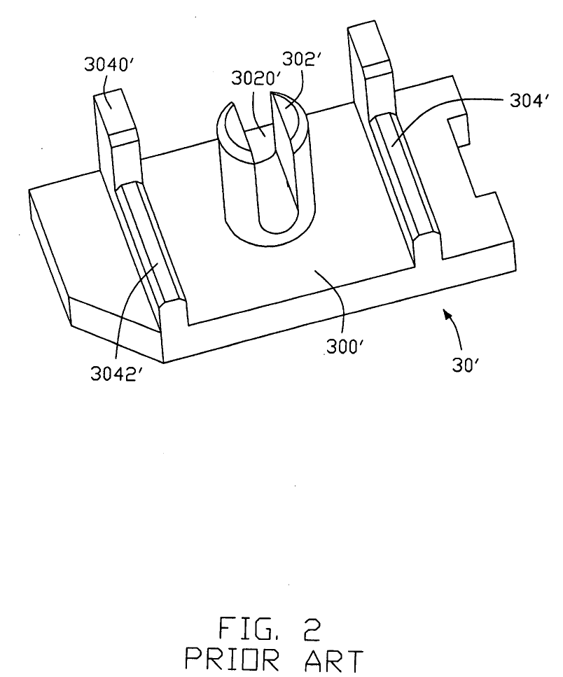

FIG. 3 is an exploded, isometric view of an electrical connector assembly according to a preferred embodiment of the present invention;

FIG. 4 is similar to FIG. 3, but showing an isometric view of the electrical connector assembly of FIG. 3 from another view;

FIG. 5 is similar to FIG. 3, but showing an isometric view of the pick up cap of FIG. 3 from another view; and

FIG. 6 is an assembled, isometric view of the electrical connector assembly of FIG. 3.

### DETAILED DESCRIPTION OF THE PREFERRED EMBODIMENT

Reference will now be made to describe the preferred embodiment of the present invention in detail.

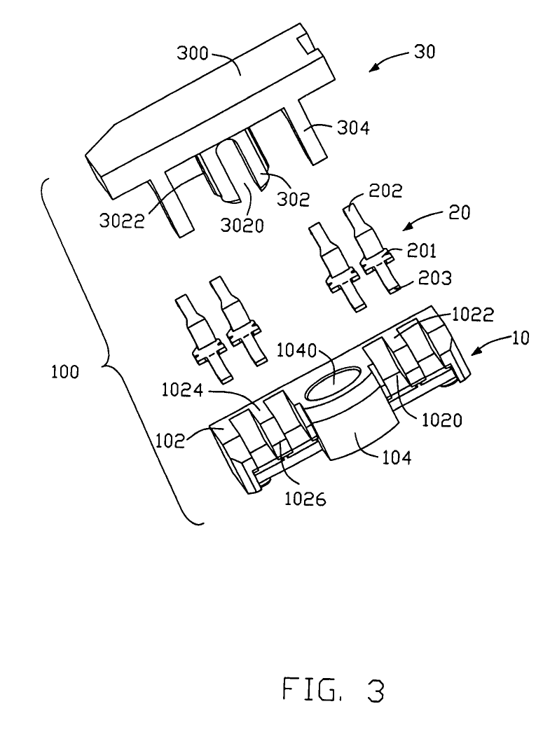

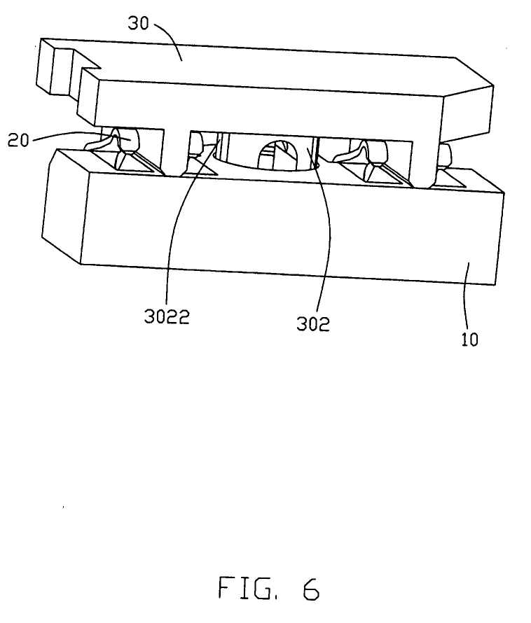

Referring to FIGS. 3-6, an electrical connector assembly 100 of the present invention includes an electrical connector with an insulated base 10 and a plurality of terminals 20 residing in the base 10, and a pick up cap 30 mounted on the electrical connector.

The insulated base 10 has a base member 102 and a conjugate member 104. The base member 102 defines a multiplicity of passageways 1020 receiving a corresponding number of terminals 20. The conjugate member 104 defines a conjugate hole 1040. A pair of parallel spaced ridges 1022 with a first lateral face 1024 and a second lateral face 1026 is adapted for engagement with respective engaging projection 304 and stand on opposite sides of the conjugate member.

A plurality of terminals 20 is planted on the insulated base 10. Each contact 20 integrally forms a base portion 201, a first arm portion 202 extending upwardly from the base portion 201 and a second arm portion 203 extending from a distal end of the base portion 201. The arm portions are used for electrically connecting with circuit substrate, such as a PCB.

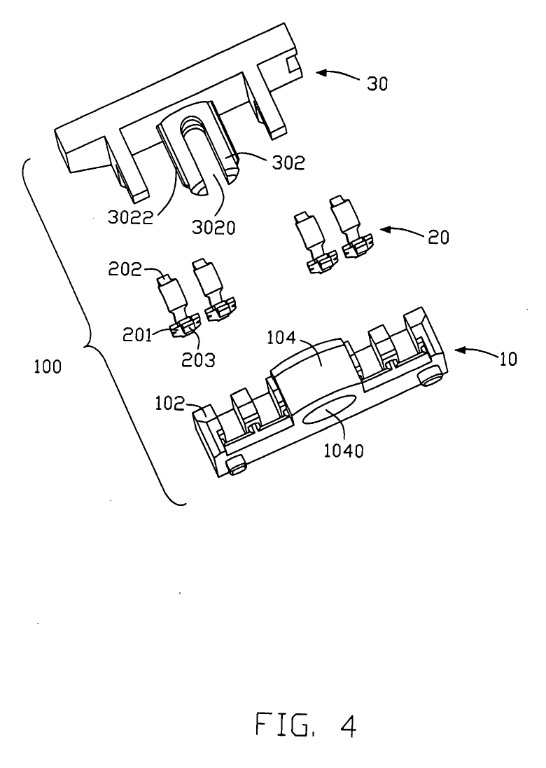

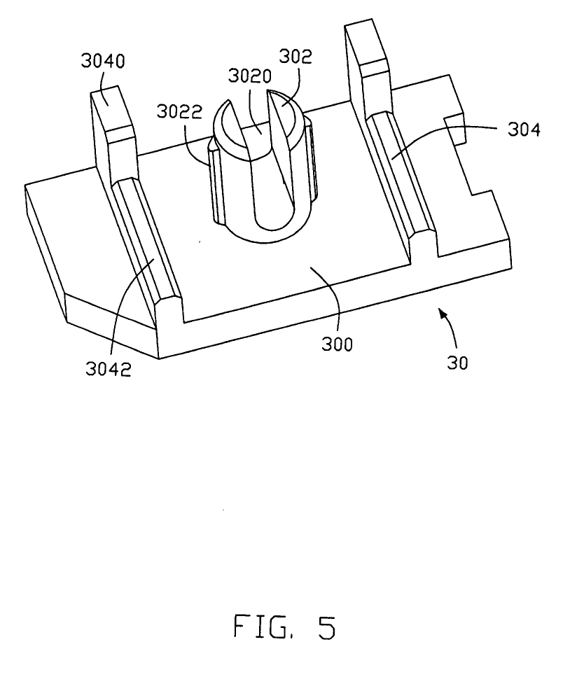

The pick up cap 30 as shown in FIGS. 4-5 is adapted to carry insulated base 10. It is appreciated that the pick up cap 30 can be used to carry other types of insulated bases, depending on the specific use.

The pick up cap 30 has a plate-like body, which is formed with a smooth major top surface 300 for being sucked by a vacuum device (not shown), and a bottom surface opposite to the top surface 300 for mating with the insulated base 10.

Referring to FIG. 5, the pick up cap 30 defines a conjugate post 302 with a recess 3020 and a plurality of interferential ribs 3022. The conjugate post 302 has a different configuration, such as a column configuration and the diameter of the conjugate post 302 is smaller than the conjugate hole 1040 of the insulated base 10. The recess 3020 traverses the conjugate post 302 and the ribs 3022 are symmetrically disposed on the post 302 in a diametrical direction, protruding outwardly from the sidewall of the conjugate post 302.

The conjugate post 302 extends from the middle of bottom surface away from the top surface 300 of the pick up cap 30, for coupling in the corresponding conjugate hole 1040 formed on the insulated base 10, so that the insulated base 10 and the pick up cap 30 mate tightly with each other by the interference of the interferential ribs 3022 and the conjugate hole 1040.

The pick up cap 30 is formed with a pair of engaging projections 304 with a first mating face 3042 and a second mating face 3040, extending from the bottom surface thereof. The first mating face 3042 is adapted to face the first lateral face 1024 of the insulated base 10 and the seconding mating face 3040 adapted to face the second lateral face 1026 of the insulated base 10, thereby holding the pick up cap 30 and the insulated base 10 in interference fits.

In assembly, the terminals 20 are pre-inserted into the respective passageways 1020, and the pick up cap 30 is attached to the insulated base 10 by the combination of the ribs 3022 and the conjugate hole 1040 when the conjugate post 302 is received in the conjugate hole 1040 and the parallel spaced ridges 1022 engage with respective engaging projection 304.

In use, the pick up cap 30 mounted onto the insulated base 10. A vacuum suction device is then used to suck the pick up cap 30 and position it to a predetermined position on a circuit substrate. The circuit substrate can be a printed circuit board (PCB). When the insulated base 10 is positioned on the predetermined position, an infrared emitter is used to heat up the tin on the PCB to melt. Then the connector and the PCB are cooled down naturally for surely soldering the insulated base 10 to the PCB.

With this configuration, the interferential ribs abut against the interior wall surface of the conjugate hole, thereby holding the pick up cap 30 and the insulated base 10 in interference fits. Thus, there is a reserved space to hold the plastic scrap produced by the conjugate post 302 and the conjugate hole 1040 when the electrical connector is mating with the pick up cap 30, so that the pick up cap 30 can be easily mounted on the electrical connector. In addition, the dimension of the rid 3022 can be altered to meet different requirements. Therefore, the conjugate hole 1040 is free from being damaged by the conjugate post 302 and a reliable interconnection between the insulated base 10 and the pick up cap 30 is ensured.

While the present invention has been described with reference to a specific embodiment, the description of the invention is illustrative and is not to be construed as limiting the invention. Various modifications to the present invention can be made to the preferred embodiment by those skilled in the art without departing from the true spirit and scope of the invention as defined by the appended claims.

What is claimed is:

1. An electrical connector assembly comprising:
a base defining a plurality of passageways and a conjugate member, the conjugate member having a hole;
a plurality of terminals residing in corresponding passageways, respectively; and
a pick up cap being detachably mounted on the base and defining a conjugate post, the conjugate post having a plurality of interferential ribs for abutting against the interior wall surface of the conjugate hole.

2. An electrical connector assembly as defined in claim 1, wherein a recess is provided to traverse the post.

3. An electrical connector assembly as defined in claim 2, wherein the conjugate post has two ribs.

4. An electrical connector assembly as defined in claim 3, wherein the conjugate post is formed as a column configuration and the ribs are symmetrically disposed on the post in a diametrical direction.

5. The electrical connector assembly as defined in claim 1, wherein the base comprises a pair of ridges on opposite sides of the conjugate member and the pick-up cap defines a pair of engaging projections on opposite sides of the post for engaging with the ridges.

6. An electrical connector assembly comprising:
an insulative housing including a center portion with a hole therein and a plurality of passageways symmetrically located by two sides of the center portion;
a plurality of contacts disposed in the corresponding passageways, respectively; and
a pick-up cap including a suction plate with a post extending downwardly from an undersurface thereof; wherein
at least one of said post and said hole is equipped with a plurality of downward ribs around a periphery thereof for interferential engagement with the other.

7. The assembly as claimed in claim 6, wherein the post defines a recess extending downwardly in communication with an exterior

8. The assembly as claimed in claim 6, wherein the hole extends through the center portion.

9. The assembly as claimed in claim 6, wherein the ribs are formed on the post.

10. The assembly as claimed in claim 9, wherein a bottom end of the rib is higher than a bottom end of the post so as to assure an easy initial coupling between the hole and the post before the rib is interferentially engaged within the hole.
